(19) United States
(12) Patent Application Publication
(10) Pub. No.: US 2008/0231492 A1
(43) Pub. Date: Sep. 25, 2008

(54) System and method for application dependent universal remote control

(76) Inventors: Robert Hardacker, Escondido, CA (US); Thomas Patrick Dawson, Escondido, CA (US); Christopher Jensen Read, San Diego, CA (US)

Correspondence Address: ROGITZ & ASSOCIATES, 750 B STREET, SUITE 3120, SAN DIEGO, CA, 92101, US

(21) Appl. No.: 11/726,560

(22) Filed: Mar. 22, 2007

(51) Int. Cl. G08C 19/12

(52) U.S. Cl. 341/176

(57) ABSTRACT

A remote control device includes one or more mode buttons which, when manipulated, cause plural controlled devices to assume preset configurations.

### FIELD OF THE INVENTION

The present invention relates generally to systems and methods for application dependent universal remote controls.

### BACKGROUND OF THE INVENTION

In an effort to resolve the burden on users from possessing a confusing number of remote control devices, e.g., one each for a TV, a personal video recorder (PVR), a digital video disk (DVD) player, a set-top box (STB), etc., universal remote controls and related systems have been provided by the present assignee to operate all of the components a user might have in a home network. Examples include the following of the present assignees' co-pending patent applications, incorporated herein by reference: Ser. No. 11/583,524, filed Oct. 18, 2006 (directed to visualizing a diagram of a home network); Ser. No. 11/601,973, filed Nov. 20, 2006 (directed to a TV-centric component mapping system); Ser. No. 11/545,377, filed Oct. 10, 2006 (directed to mapping remote control device keys to functions); Ser. No. 11/214,177, filed Aug. 9, 2005 (directed to a multi-function button on a remote control device); and Ser. No. 11/541,272, filed Sep. 29, 2006 (directed to using RFID to program a remote control device and train a user how to use it).

As understood herein, different buttons on the remote can assume different functions depending on which component the user has selected for control, making it difficult for the user to know or remember which button performs which particular function for any given component. As further recognized herein, certain applications typically entail establishing the same set of settings across plural devices. With these recognitions in mind, the invention herein is provided.

### SUMMARY OF THE INVENTION

A system has a TV, a remote control configured for communicating with the TV, and one or more components configured for communicating with the TV to cause the TV to display video information from the component and/or to cause the component to display audio information from the TV. A mode element on the remote control can be pressed a single time to cause the remote control to send a command to the TV and a command to the component. The commands can be established by an end user.

If desired, the commands may be established based on information from the TV. The information from the TV that is used to establish the commands can be received by the TV over the Internet from a server. The commands also may be established by identifying the component using NFC between the remote control and the component. In this case the remote control can inform the TV using near field communications (NFC), RF, infrared, or some other communication mode information about one or more components so that the TV can query an Internet server for appropriate control information for the component and connectivity information about how the component connects to the TV. The server recommends ways to connect including but not limited to pictures presented on the TV and/or on the remote control when a liquid crystal display (LCD) is provided thereon. The user can inform the remote control/TV which method of connection is actually implemented.

In non-limiting embodiments the component is a disk player and manipulation of the mode element causes the remote control to send an “energize” signal to the TV and the disk player and to automatically command the TV to switch input to the component. In this non-limiting embodiment manipulation of the mode element further causes the remote control to command a sound system to automatically switch input to the disk player and to respond to volume up/down commands from the remote control. Still further, manipulation of the mode element further can cause the remote control to send an audio mute command to the TV and to cause at least one TV function to be disabled. If desired, the TV can display information relating to the commands, and a user can manipulate the remote control to establish the commands.

In another aspect, a method for facilitating simultaneous control a TV and a disk player includes enabling a user to establish at least portions of a use case by means of a TV and a remote control, and invoking the use case using a single manipulation of the remote control. The use case includes causing first and second components in a home entertainment system to respectively execute first and second acts.

In still another aspect, a remote control has a portable hand held housing and wireless transmission means supported by the housing for communicating commands to home entertainment system components. A mode element is on the housing and is manipulable once to cause the transmission means to send respective first and second commands to first and second components.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system of the present invention;

FIG. 2 is a plan view of a non-limiting remote control in accordance with present principles; and

FIG. 3 is a flow chart showing a non-limiting implementation of how the mode commands are established.

### DETAILED DESCRIPTION OF THE PREFERRED EMBODIMENT

The present invention recognizes that viewing TV often involves the use of one or more additional components with the TV such as cable set top box (STB), digital video recorder (DVR), home theater (HT) system, etc., and that these devices often duplicate functions and require multiple setting changes to work properly together. A non-limiting solution to this given below includes provision of a single mode button that turns on the TV, HT system, and cable STB while setting the TV to “input 1” to accept the cable TV input, and the HT system to “video 1” to select the digital audio output from the TV for use in driving the sound reinforcement system loudspeakers. Also, as discussed further below the TV speakers can be muted and the remote control (RC) volume control permitted to affect the HT volume and not the TV volume. The channel up/down control might affect only the cable STB while leaving the TV channel setting alone.

Moreover, understanding that it is desirable to simplify programming the RC to appropriately control these different components with a single button, methods are described to acquire the configuration of the components, and usage scenarios for intuitive and automatic control settings that allow a single button press to control different functions in different components enabling seamless enjoyment by the user.

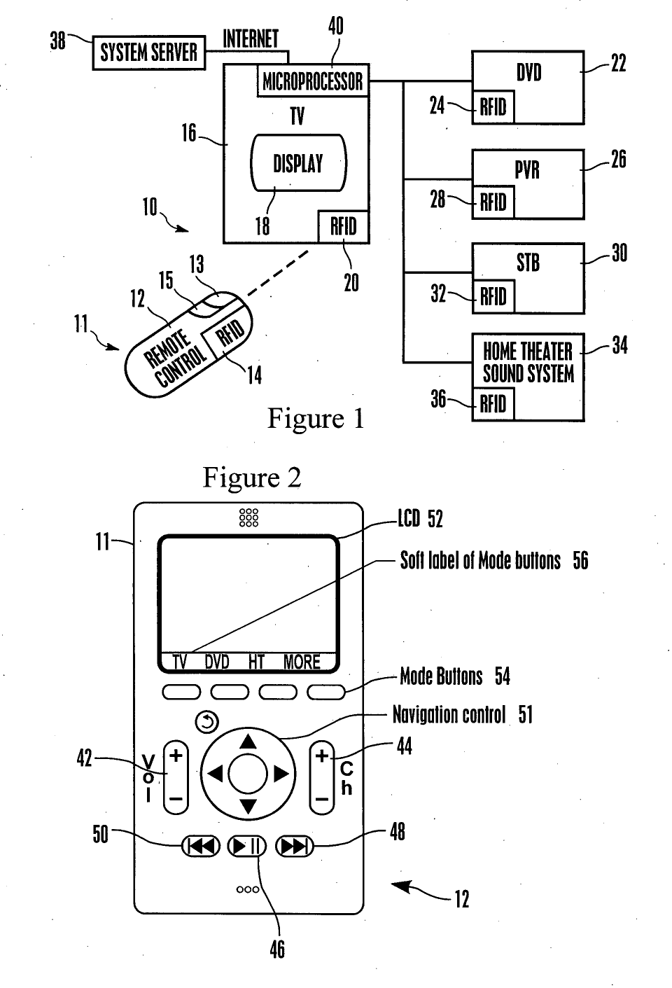

Referring initially to FIG. 1, a system is shown, generally designated 10, which includes a portable hand-held housing 11 embodying a remote control device 12 having, in the preferred embodiment shown, an RF or IR transmitter 13 for sending remote commands in accordance with principles known in the art and also having a relatively shorter range radiofrequency identifier (RFID) reader 14 for communicating in accordance with RFID principles known in the art. The remote control 12 also has a RC processor 15 connected to the components of the remote control 12 shown in FIGS. 1 and 2 and discussed further below to execute aspects of the present logic. In any case, the remote control may communicate using RFID and may also communicate via another RF band or via infrared with a TV 16 having a display 18. The TV 16 may also have an RFID reader 20 mounted on it.

Additional components may be controlled by the remote control device 12, including, by way of non-limiting example, a DVD player 22 with associated RFID device 24, a personal video recorder (PVR) 26 with associated RFID device 28, a STB 30 with associated RFID device 32, and a home theater sound system 34 with associated RFID device 36, all of which components can communicate with the TV via wired or wireless links. The location of each RFID device on its respective component may be visually indicated by, e.g., lines or other markings.

The component RFID devices can be a so-called Felica device or Near Field Communications (NFC) devices. An NFC or a Felica device when used in accordance with the present invention has a microprocessor and non-volatile memory (NVM) typically embodied in a Smart Card. The component RFID devices 24, 28, 32 may be implemented by tokens resembling a small disk and/or integrated circuit that are unpowered. In any case, placing a component RFID device (including an NFC device with chip and antenna or Felica device) close (e.g., within an inch or so) to the RFID reader 14 of the remote control 12 energizes the Felica Card, token, or chip. It can then be read and/or written to by the reader 14.

The information in the NVM of the components 22, 26, 30 can thus be transferred to the remote control 12 to program the functionality of the remote control 12. Details of such information transfer are disclosed in the above-mentioned U.S. patent application Ser. No. 11/545,377.

In an alternate implementation the information can be conveyed from the remote control 12 to the TV 16. As understood herein, the TV 16 has more processing power than the remote control 12, so that the TV 16 can program the remote control 12 to account for components that are not in database of the remote control 12. This new functionality may be conveyed to the TV in one of two ways. The remote control 12 can write information read from the RFID device of the component to the NVM of the TV 16. Or, information can be exchanged between the reader 20 of the TV and the reader 14 of the remote control 12. Still another alternative is to take the component such as the STB 30 directly to the TV 16 and allow the TV RFID reader 20 to read the STB NVM by means of the STB RFID device 32, then allow the TV to update the remote control 12.

In any case, a user can touch (or closely juxtapose) the RFID reader 14 on the remote control 12 with each RFID device on the components 22, 26, and 30 in succession, potentially aided by the visual indications disclosed above, to cause information in each successive component to automatically be read by the remote control 12 and/or to cause the remote control 12 to transfer information to the components. The information can include functions of various buttons on the remote control 12 pertaining to that component, along with, if desired, signaling methods. This communication is done using RFID information exchange principles known in the art, automatically once the RFID devices are close enough to each other to trigger information exchange. Then, the user can touch (or closely juxtapose) the RFID device 14 on the remote control 12 with the RFID device 20 on the TV 16 to transfer the information from the components 22, 26, 30 to the TV. As disclosed further below, some of the exchanged information may be provided over the Internet from a system server 38 to a TV processor 40 in the TV.

Now referring to FIG. 2, one non-limiting implementation of the remote control 12 can be seen. As shown, the remote control 12 may include conventional input elements such as but not limited to a volume up/down rocker 42, a channel up/down rocker 44, a “play/stop” button or pad 46, a “fast forward” button or pad 48, and a “reverse” or rewind button or pad 50. Additionally, the remote control 12 may have a navigation control element 51 for moving a screen cursor around the TV screen in accordance with principles known in the art, and a visual display such as a liquid crystal display (LCD) 52 may also be included on the remote control 12.

In addition to the above input and output elements, the remote control 12 shown in FIG. 2 may include one or more mode buttons or pads 54, and a soft label 56 of each mode button or pad 54 may be presented on the LCD 52. In the embodiment shown, a “TV” mode button, a “DVD” mode button, a “home theater” mode button, and a “more” mode button 54 are provided.

As set forth further below, depressing a mode button (e.g., the “DVD” button 54) a single time results in sending simultaneous commands through the transmitter 13 to plural components in FIG. 1, e.g., to the DVD player 22, the TV 16, and home theater sound system 34. By “simultaneous” is not necessarily meant “at the same exact instance in time” but rather “automatically and in rapid succession” so that to a human user it appears to be simultaneous.

For instance, pressing the “DVD” mode button 54 can cause the remote control 12 to send an “energize” signal to all three components, cause the remote control 12 to automatically signal the TV to switch input to the DVD player 22 input, and automatically switch the home theater sound system 34 input to the DVD player 22 audio input. Also, by pressing the “DVD” mode button 54, in non-limiting implementations the remote control 12 can signal the TV 16 to mute the TV audio (so that the only audio heard is from the home theater audio system 34), disable the TV channel up/down function and other TV control functions, shift TV display settings from “normal” to “professional”, and establish the home theater audio system 34 output volume to a predetermined volume, with predetermined volumes being established for respective media, e.g., one volume for a DVD and another for a CD. The home theater audio system subsequently is caused to respond to volume up/down commands from the remote control 12. The DVD player can be caused to automatically present a menu and set the language to “English” when the “DVD” mode button is depressed.

Accordingly, by manipulating the “DVD” mode button 54, the remote control 12 is caused to send plural signals to cause various components to assume specific configurations, referred to herein as a “use case”. As set forth further below, the configurations may be altered by a user. Depressing the “TV” mode button may likewise establish another manufacturer-defined or user-defined use case, while depressing the home theater mode button may establish yet a third use case.

Further, the “more” mode button 54 is essentially a menu button for causing the LCD 52 to display a menu of commands caused by depressing the other three mode buttons. Toggling the “more” mode button 54 once might present the commands generated by depressing the “DVD” mode button, and toggling the “more” button a second time might cause the LCD 52 to display a menu of commands caused by depressing the “TV” mode button. A third toggle of the “more” mode button can cause the LCD 52 to display the commands caused by manipulating the home theater mode button 54. Or, manipulating the “more” or menu button once might result in all three command menus (for each of the three remaining mode buttons) to be presented on the LCD 52 simultaneously, with a user being able to select one of interest using, e.g., the navigation control element 51 to cause the selected menu to zoom to full LCD 52 screen size. Yet again, a list of the three menus may be displayed for selection by the user.

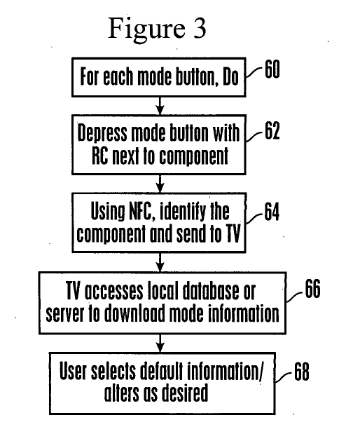

While the use case functions of each mode button 54 may be preprogrammed once by the manufacturer and never subsequently changed, FIG. 3 illustrates non-limiting logic for dynamically programming the functions of each mode button 54. The logic starts at block 60 for each of the use case mode buttons, wherein at block 62 the user depresses the mode button being programmed with the remote control 12 closely juxtaposed with each of the system components (in succession) that are to be included in the particular mode. As the remote control 12 is transported close enough to each component to permit near field communications, the components send identifying information to the remote control 12. This information is collected and provided to the TV 16 at block 64 when the remote control 12 is sufficiently close to the TV. While NFC is contemplated it is to be understood that the above information may be collected and communicated using other communication methods such as USB, etc.

Proceeding to block 66, the TV 16 accesses a local database or, more preferably, the server 38 via the Internet to obtain component capability information based on the information provided by the remote control 12. This information indicates how each particular component might be configured for the use case represented by the mode button 54, and can include a suggested default configuration for each affected component as well as necessary control codes.

The configurations can be displayed on the TV for selection thereof and/or modification thereof by a user at block 68, with the user selections being stored in the remote control 12 so that upon subsequent manipulation of the particular mode button, the simultaneous signals from the transmitter 13 to the various components to establish the use case as described above are sent. Recommendations can also be provided for particular connections and particular use cases and displayed as a network map on the TV.

In some implementations, after a use case is established for each mode button, manual overrides subsequently may be permitted. In any case, with the above logic the user not only is apprised of what each use case (i.e., each of the use case mode buttons) entails, but can, in non-limiting implementations, participate in establishing the parameters of each use case.

Once connectivity is established between the remote control and the components to be controlled, indicated by either user input or automatic discovery of the connectivity by means of NFC or other means, templates for establishing use cases may be applied.

Additional details of non-limiting implementations of one or more of the above steps are set forth in the above-mentioned U.S. patent applications.

As described above, methods for selecting components for each use case can be physical or near-physical contact (e.g., Felica) or virtual selection from the map using arrow keys. Or, a multiaxis controller as described in the above-incorporated U.S. patent application Ser. No. 11/541,272 can be used.

When the above-described map is displayed, a user can manipulate the remote control 12 to “drag and drop” components where desired and to draw connections between components on the TV screen. Thus, a user can draw a connecting map and assign that to a “mode” map including, but not limited to, device interconnections and which devices are on or off.

While the particular SYSTEM AND METHOD FOR APPLICATION DEPENDENT UNIVERSAL REMOTE CONTROL is herein shown and described in detail, it is to be understood that the subject matter which is encompassed by the present invention is limited only by the claims.

What is claimed is:

1. A system, comprising:
at least one TV;
at least one remote control configured for communicating with the TV;
at least one component configured for communicating with the TV to cause the TV to display at least video information from the component and/or to cause the component to display at least audio information from the TV;
at least one mode element on the remote control, the remote control sending at least one command to the TV and at least one command to the component in response to a single manipulation of the mode element, wherein the commands are established at least in part by an end user.

2. The system of claim 1, wherein the commands are established at least in part based on information from the TV.

3. The system of claim 2, wherein the information from the TV that is used to establish the commands is received by the TV over the Internet from a server and/or a server database.

4. The system of claim 2, wherein the commands are established at least in part by identifying at least the component using NFC between the remote control and the component.

5. The system of claim 1, wherein the component is a disk player and manipulation of the mode element causes the remote control to send an “energize” signal to the TV and the disk player and to automatically command the TV to switch input to the component.

6. The system of claim 5, wherein manipulation of the mode element further causes the remote control to command a sound system to automatically switch input to the disk player and to respond to volume up/down commands from the remote control.

7. The system of claim 6, wherein manipulation of the mode element further causes the remote control to send an audio mute command to the TV and to cause at least one TV function to be disabled.

8. The system of claim 2, wherein the TV displays information relating to the commands, and a user can manipulate the remote control to establish the commands.

9. A method for facilitating simultaneous control at least of a TV and a disk player, comprising:
enabling a user to establish at least portions of a use case by means of a TV and a remote control; and
invoking the use case using a single manipulation of the remote control, the use case including causing at least first and second components in a home entertainment system to respectively execute at least first and second acts.

10. The method of claim 9, wherein the acts are established at least in part by an end user.

11. The method of claim 9, wherein the acts are established at least in part based on information from the TV.

12. The method of claim 11, wherein the information from the TV that is used to establish the acts is received by the TV over the Internet from a server.

13. The method of claim 11, wherein the acts are established at least in part by identifying at least the component using NFC between the remote control and the first component.

14. The method of claim 9, wherein the first component is a disk player and manipulation of a mode element on the remote control causes the remote control to send an “energize” signal to the TV and the disk player and to automatically command the TV to switch input to the component.

15. The method of claim 14, wherein manipulation of the mode element further causes the remote control to command a sound system to automatically switch input to the disk player and to respond to volume up/down commands from the remote control.

16. The method of claim 15, wherein manipulation of the mode element further causes the remote control to send an audio mute command to the TV and to cause at least one TV function to be disabled.

17. A remote control, comprising:
a portable hand held housing;
wireless transmission means supported by the housing for communicating commands to home entertainment system components; and
at least one mode element on the housing and manipulable once to cause the transmission means to send at least respective first and second commands to first and second components.

18. The remote control of claim 17, wherein the commands are established at least in part by an end user.

19. The remote control of claim 17, wherein the commands are established at least in part based on information from the TV.

20. The remote control of claim 19, wherein the information from the TV that is used to establish the commands is received by the TV over the Internet from a server.
